(19) United States
(12) Patent Application Publication
(10) Pub. No.: US 2013/0307437 A1
(43) Pub. Date: Nov. 21, 2013

(54) Energy Density Intensifier for Accelerating, Compressing and Trapping Charged Particles in a Solenoid Magnetic Field

(71) Applicant: Mark Edward Morehouse, Costa Mesa, CA (US)

(72) Inventor: Mark Edward Morehouse, Costa Mesa, CA (US)

(21) Appl. No.: 13/473,598

(22) Filed: May 17, 2012

(51) Int. Cl. H05H 7/00

(52) U.S. Cl. 315/501

(57) ABSTRACT

The Energy Density Intensifier for Accelerating, Compressing and Trapping Charged Particles in a Solenoid Magnetic Field is a method and apparatus operable upon a population of charged particles possessing an initial angular momentum (magnetic moment) within a vacuum mirror solenoid magnetic field. An electric field is applied generally along the longitudinal magnetic field axis accelerating, compressing and trapping the charged particles by their magnetic moment against the radial component of the field gradient of the mirror magnetic field of the solenoid magnetic field, by means of the electric force established by the electric field.

### FIELD OF THE INVENTION

The present invention regards a charged particle accelerator operating in a solenoidal mirror magnetic field. And more specifically an accelerator that requires the particles have an initial azimuthal (magnetic moment) momentum, wherein the acceleration results in the particles being trapped against the minor gradient of the solenoidal mirror magnetic field by means of an axial electric field.

### BACKGROUND OF THE PRESENT INVENTION

The present invention seeks to achieve the objective of providing a means and a method for the acceleration, confinement, trapping and neutralization of a population of stored charged particles in a magnetic field. Prior art references to the present disclosure, either in the scientific literature or in prior patents have not been found. Although the concept is simple and will be immediately evident to those with ordinary skill in the art.

### BRIEF DESCRIPTION OF THE INVENTION

This disclosure teaches certain benefits in construction and use which give rise to the objectives described below.

The Energy Density Intensifier provides a method and apparatus for accelerating, compressing, neutralizing and trapping a charged particle beam using a mirror solenoid having an axis of symmetry and supported within a vacuum space. A mirror magnetic field is generally weakest in the center and increases near the minor coils, where a generally radial component of the magnetic field appears. Charged particles having azimuthal momentum are confined radially by the axial magnetic field, but any axial momentum is not influenced by the axial component of the magnetic field. However, where the axial field increases (mirror field) a radial component of magnetic field exists. The radial component of the solenoid field exerts an axial acceleration to the azimuthal momentum, driving the particles away from the increasing field. Thus an azimuthal component of momentum is required for the axial force to develop on the particles. A generally axial electric field is introduced into the vacuum space generally between the particle entrance (source exit electrode) and an electrode established beyond the minor field, where the ions are not allowed to enter due to the interaction of their magnetic moments and the radial component of the minor magnetic field.

The objective of the present invention is to provide a means to increase the energy and the density and to trap charged particles stored in a magnetic field. The present invention does these functions as well as provide a means for space charge neutralization. The present invention operates on a basic principle of ion orbit physics that equates the magnetic moment and the axial momentum of the particle to the maximum magnetic field. In plasma physics the minor condition is when the energy of an ion is equal to the magnetic moment times the magnetic field, the charged particle can go no further up the magnetic field: ε=μB, where ε=energy, μ=mv²/2B, is the magnetic moment, and B is magnetic field strength, m is mass and v is velocity.

The present method allows for a further increase of an ion's energy if it initially has a non zero magnetic moment by drawing it deeper into a magnetic field than it's initial axial energy would allow. An added benefit arises because an ion drawn into a higher magnetic field has a smaller cyclotron radius: R_{L}=mv/Bq, where q is the particle charge state. A smaller charged particle orbit radius increases the stored ion density because the cross sectional area of the stored charged particles is lower as A=πr². The present declaration thereby increases both the energy and the density of a stored ion beam as well as providing ion trapping which has benefits to those fields of ion beams and plasma physics that endeavor to reach high energy densities for increased particle interaction rates.

### BRIEF DESCRIPTION OF THE INVENTION

A method and apparatus for accelerating, compressing, neutralizing and trapping an ion beam using a minor solenoid having an axis of symmetry and supported within a vacuum space is presented. Charged particles are assumed, previously introduced into the magnetic field possessing a magnetic moment, μ. Charged particles possessing a magnetic moment, that additionally have an axial momentum, parallel to the magnetic field will reflect off the minor component of the solenoid field, if the mirror magnetic field is adequate. Charged particles carrying a magnetic moment and moving into an increasing magnetic field experience a counteracting force due to the radial component of the magnetic field. As the solenoid field increases the azimuthal energy increases, E₂=E₁(B₂/B₁), at the expense of the axial energy. The spiral angle, θ, of the ion orbit is determined by the ratio of azimuthal to axial velocity,

$$θ = {tan}^{- 1} \frac{{v}_{⊥}}{{v}_{\vert \vert}} , and \frac{sin {θ}_{m}}{\sqrt{{B}_{m}}} = \frac{sin {θ}_{M}}{\sqrt{{B}_{M}}} ,$$

where the subscripts m and M, indicate minimum and maximum values of the magnetic field. The point at which sin θ_{M} is unity, the velocity of the ion along the field line is zero, which is the minor reflection point. Thus an ion with both azimuthal and axial momentum exists in the central minimum in a mirror field the orbit will oscillate back and forth between the two mirror ends. The particle trajectory converts axial momentum into azimuthal momentum and then back to azimuthal as it approaches and recedes from the minor point. The increasing magnetic field increases angular momentum, P_{φ}=mωr,

$$ω = \frac{q}{M} * B ,$$

so P_{θ}˜B, where, ω=2πfᵢ, is radian cyclotron frequency. Because no work is done on the particle the total energy does not change so a gain in one component of energy reduces the other orthogonal energy. In addition to increasing the angular momentum the increasing magnetic field also reduces the orbit radius, increasing density,

$${R}_{L 1} = {{R}_{L 2} ( \frac{{B}_{1}}{{B}_{2}} )}^{\frac{1}{2}} ,$$

where B₁ and B₂ are initial and final magnetic field strength, and R_{L1} and R_{L2} are Larmor radius in field B₁ and B₂ respectively.

The charged particles so established are acted upon by an electric field established within the solenoid field space, such as to draw the charged particles against the magnetic field gradient at the mirror end of the minor solenoid. The electrostatic field so established is introduced into the solenoid field region by any number of electrodes situated at any of a multitude of points or surfaces facing the vacuum confinement space. Such electrodes may be attached to the walls or facing components of the plasma vacuum space or suspended within the vacuum space. Such electrodes may be charged positive, negative or a varying potential may be applied to the various electrodes to establish any number of electric field geometries to achieved the intended objective. In a preferred embodiment the electrode is energized with a simple dc bias (electrostatic) and either attracts charged particles towards higher magnetic fields (negative electrode) or (positive electrode) repels charged particles away from the lower magnetic field. The electrostatic field may be applied beyond the minor point relative to the chamber wall anywhere in between the two ends of the solenoid. Thus the electrodes do not come into contact with the charged particles. The charged particles are drawn axially against the gradient of the increasing magnetic field along the axis, Z.

The intended objective of this accelerator and compressor is to cause the charged particles to become trapped against the gradient of the magnetic field. Acceleration of an ion, against the magnetic field gradient, overcomes the opposing force of the radial component of the solenoid field (in the region of increasing magnetic field). If an ion that initially has a rotational energy E₁ in a magnetic field B₁ is later found in a magnetic field B₂, it follows from the conservation of magnetic moment that it will have an energy E₂=E₁(B₂/B₁). The ion is drawn into the magnetic field by the axial electric field until the radial component of the magnetic field counteracts the electric force, F=q(E+v×B), F=0=q(E−v×B) when E=−v×B. Thus the trapping condition is achieved.

### BRIEF DESCRIPTION OF THE DRAWINGS

FIG. 1 is a side view cross section of an embodiment of the invention where the charged particles are preexisting in the center of the minor field. The figure is presumed to be contained in a vacuum vessel that is not shown;

FIG. 2 is an axial view of some preferred embodiments of electrode configuration.

### DETAILED DESCRIPTION OF THE INVENTION:

This describes The Energy Density Intensifier for Accelerating, Trapping and Compressing Charged Particles in a Solenoid Magnetic Field and illustrates the apparatus and method of use in at least one of its preferred, best mode embodiments. Those having ordinary skill in the art may be able to make alterations and modifications to what is described herein without departing from its spirit and scope. Therefore it must be understood that what is illustrated is set forth only for the purpose of example and that it should not be taken as a limitation in the scope of the present apparatus and method of use.

Described now in detail is a method and apparatus useful for accelerating, compressing, neutralizing and trapping a charged particle beam.

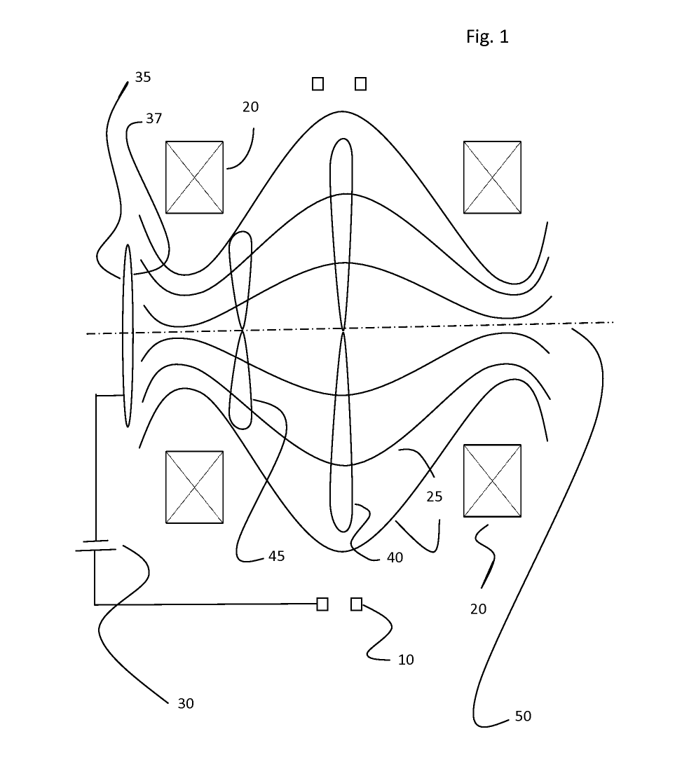

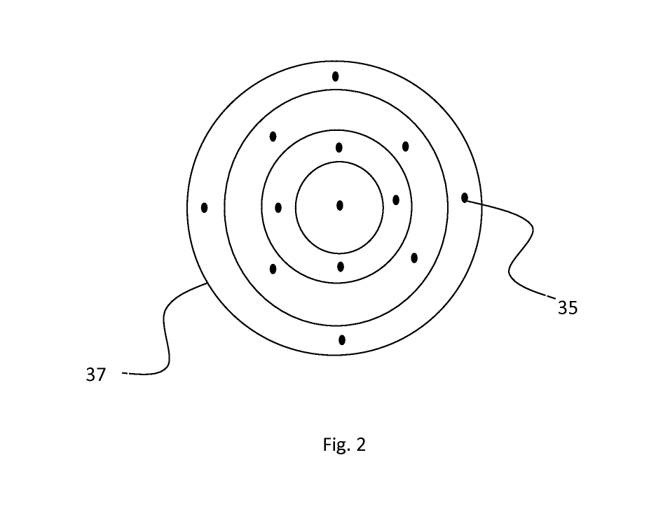

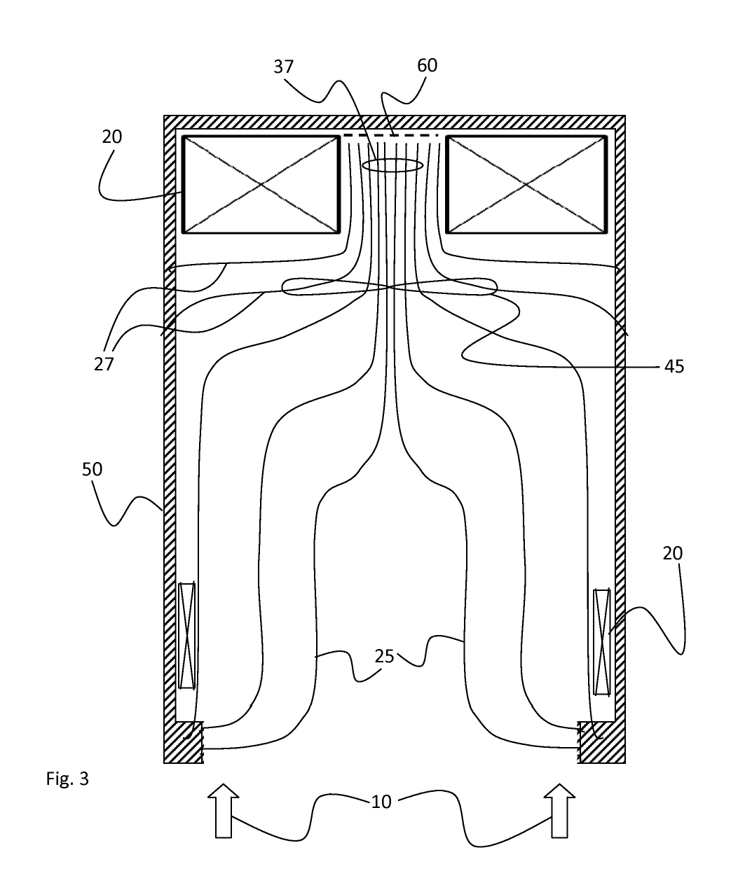

FIG. 1 shows an initial beam of particles 40 which is assumed to exist in a mirror solenoid 20 having an axis of symmetry and supported within a vacuum space (not shown). The source and means of injection of the initial charged particles 40 is not shown and is presumed to be established by any of a number of charged particle sources 10 as are well known in the field. The charged particle orbit as shown is a zero canonical angular momentum orbit which touches the axis of the magnetic field on each cycle. The charged particle source 10 technology is well developed and is referenced by U.S. Pat. No. 8,138,677 which is hereby incorporated by reference. As shown in FIG. 1. the apparatus includes a mirror magnetic field 20 showing magnetic lines of force 25. The solenoid is energized, by means not shown but which is well know in the field, by any appropriate source capable of providing adequate current to maintain a magnetic field 25 as necessary. The coil windings 20 can be either resistive or superconducting coils, or any combination thereof. A DC electrical power source 30 as well as controllable varying electric power sources 35 are shown. Power sources 30 and 35 are capable of providing voltages and currents as required by the present application, and is well know in the field. The electrical potentials provided by power sources 30 and 35 are established within the vacuum space between the charged particle source 10 and vacuum electrodes 35 beyond the axial end of the minor coils 20. The electrodes may be positioned at any appropriate position within the vacuum space that adequately serves to provide the appropriate electric field to drive the charged particles to the final trapped position 45. The electrodes may be positioned on any surface or suspended within the vacuum space and electrically insulated or exposed and of any desired shape and composed of any appropriate material as is well known in the field and appropriate to achieve the desired end. All electrodes may also be capable of providing electrons as is also well known in the field. The intended objective is to trap the charged particles in the final position 45. Thus the objective of the present patent letters is achieved, whereby a population of charged particles have been subject to acceleration (as the electrical field imparts energy to the particles), compression (as the magnetic field reduces the particle orbit radius) and trapping (as the particles are now held against the magnetic field gradient by means of the electrical field tension). FIG. 2 is an axial view of the plasma facing electrodes 35. Electrodes 35 can have any desired shape, such as multiple point electrodes 35 or ring type electrodes 37. Electrodes 35 and or ring type electrodes 37 may all be capable of emitting electrons, as heated filament type electron sources, or any other commonly known electron source technology. It is necessary to place the electrodes in positions such that the electric fields established by power sources 30 and 35 are not on any connecting magnetic field line. Electrons are free to move along magnetic field lines 25 and so would short out the power sources 30 and 35 if they are connected by such magnetic field lines 25. Electrons are not free to move across magnetic field lines 25 and so as long as electrodes 10 and 35 or 37 are positioned such as to not be connected my magnetic field lines 25 there will be an impedance to electron flow along the electric field. This limiting consideration can be overcome by proper placement of electrodes 10 and 35 and or 37.

FIG. 3 shows an axial cross section view of another preferred embodiment of the present invention. Charged particles are introduced 10 through one axial end of the solenoid magnetic field which does not have a mirror. Said particles 45 are drawn into the mirror end of the magnetic field by the electric field established between electrode 37 and vacuum vessel walls 50 and or plasma source 10 and become trapped against the radial component 27 of the mirror solenoid magnet field 25. The solenoid magnetic field is shown with a ferric hi-mu return field structure 50 also representing the vacuum chamber wall. The inner surface of the vacuum vessel may be covered with insulating material 60 as necessary to avoid different electrical potentials from being connected by magnetic field lines, or having undesired currents.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material of acts beyond the scope of the commonly defined meanings thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements literally set forth, but all equivalent structure, material or acts of performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim. Likewise any positioning of elements as literally set forth is to be recognized as being representative of an example to teach and that alternate positioning of elements performing substantially the same function obtaining to the same result are defined to be within the scope of the defined elements. Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and what incorporates the essential ideas.

The scope of this description is to be interpreted only in conjunction with the appended claims and is made clear, here, that each named inventor believes that the claimed subject matter is what is intended to be patented.

What is claimed is:

1. An apparatus for trapping, accelerating and compressing and a field of charged particles in a vacuum space, the apparatus comprising:
a mirror magnetic field solenoid energized for producing a magnetic field within the vacuum space, the minor magnetic field solenoid and the magnetic field having a common axis of symmetry;
a supply of charged particles possessing angular momentum (magnetic moment) are presumed to have been introduced into the solenoid magnetic space;
a pair of electrodes, enabled to produce AC and DC electric potentials and currents as necessary for the present application;
one of the pair of electrodes positioned generally beyond the mirror point of the solenoid magnetic field;
the other of the pair of electrodes positioned within the vacuum space such as to provide an electric field potential between the two electrodes;
said electric field potential applied with such polarity and field topology, within the vacuum space, as to provide an electrical force tending to accelerate and translate the population of charged particles into the mirror aspect of the mirror magnetic field solenoid;
the radial component of the minor magnetic field solenoid thus exerting a repelling force against the magnetic moment of the charged particles;
resulting in the establishment of an equilibrium between the two forces, which traps the charged particles, having accelerated them to higher energies and compressed them to higher densities due to the forces at play therein.

2. The charged particle accelerator of claim 1, comprising;
a single ended minor magnetic field solenoid energized for producing a magnetic field within the vacuum space, the minor magnetic field solenoid and the magnetic field having a common axis of symmetry;
a supply of charged particles possessing angular momentum (magnetic moment) are presumed to have been introduced into the solenoid magnetic space;
a pair of electrodes, enabled to produce AC and DC electric potentials and currents as necessary for the present application;
one of the pair of electrodes positioned generally beyond the mirror point of the solenoid magnetic field;
the other of the pair of electrodes positioned within the vacuum space such as to provide an electric field potential between the two electrodes;
said electric field potential applied with such polarity and field topology, within the vacuum space, as to provide an electrical force tending to accelerate and translate the population of charged particles into the mirror aspect of the single ended mirror magnetic field solenoid;
the radial component of the minor magnetic field solenoid thus exerting a repelling force against the magnetic moment of the charged particles;
resulting in the establishment of an equilibrium between the two forces, which traps the charged particles, having accelerated them to higher energies and compressed them to higher densities due to the forces at play therein.

3. The charged particle accelerator of claim 1, comprising;
a supply of charged particles possessing angular momentum are assumed to have been introduced into the solenoid magnetic space;
an electric field potential applied between separate electrodes positions within the vacuum magnetic space, wherein the electric field potential accelerates and translates the charged particles into the increasing magnetic field of the minor component of the mirror magnetic field, wherein the electric field acts to trap the charged particles within the vacuum magnetic field space.

4. The apparatus of claim 1 wherein the charged particles are injected radially into the magnetic field.

5. The apparatus of claim 2 wherein the charged particles are injected from one axial end.

6. The apparatus of claim 1 wherein the charged particles are injected from a radial position distal from the minor.

7. The apparatus of claim 2 wherein the charged particles are injected from an axial position distal from the mirror.

8. The apparatus of claim 1 wherein one or more of the electric potential electrodes are driven by a direct current DC electrostatic field.

9. The apparatus of claim 2 wherein one or more of the electric potential electrodes are driven by a direct current DC electrostatic field.

10. The apparatus of claim 1 wherein one or more of the electric potential electrodes are driven by controllable time varying alternating current AC electric fields.

11. The apparatus of claim 2 wherein one or more of the electric potential electrodes are driven by controllable time varying alternating current AC electric fields.

12. The apparatus of claim 1 wherein one or more of the electric potential electrodes are driven by a combination of direct current DC electrostatic and controllable time varying AC electric fields.

13. The apparatus of claim 2 wherein one or more of the electric potential electrodes are driven by a combination of direct current DC electrostatic and controllable time varying AC electric fields.

14. The apparatus of claim 1 wherein one or more of the electric potential electrodes are electron sources for the vacuum space.

15. The apparatus of claim 2 wherein one or more of the electric potential electrodes are electron sources for the vacuum space.

16. A method for accelerating, compressing and trapping a population of charged particles in a minor type magnetic field, the method comprising the steps of;
a) providing a mirror type solenoid magnetic field within a vacuum space; a pair of electrodes capable of establishing an electric field generally applied between the exit of the charged particle source and a position beyond the magnetic minor; an electric power source capable of energizing said electrode pair;
b) establishing a population of charged particles confined within the mirror type solenoidal magnetic field;
c) energizing the electric field electrodes; thereby establishing an electric field of such sense as to drive the charged particle population into the mirror component of the minor solenoid field;
d) causing the charged particles to become further energized and trapped or confined within the vacuum magnetic field.
